(19) United States
(12) Patent Application Publication
(10) Pub. No.: US 2008/0116805 A1
(43) Pub. Date: May 22, 2008

(54) Plasma display panel (PDP)

(76) Inventor: Jung-Suk Song, Suwon-si (KR)

Correspondence Address: ROBERT E. BUSHNELL, 1522 K STREET NW, SUITE 300, WASHINGTON, DC, 20005-1202, US

(21) Appl. No.: 11/898,507

(22) Filed: Sep. 12, 2007

(30) Foreign Application Priority Data
Nov. 21, 2006 (KR) 10-2006-0115152

(51) Int. Cl. H01J 17/49

(52) U.S. Cl. 313/586

(57) ABSTRACT

A Plasma Display Panel (PDP) having reduced manufacturing costs and simultaneously displaying an image having a uniform luminance supplies a sustain pulse only to scan electrodes among scan electrodes and sustain electrodes arranged on a top substrate during a sustain period of each of a plurality of subfields. The PDP includes: a top dielectric layer arranged on the scan and sustain electrodes; a passivation layer arranged on the top dielectric layer; address electrodes arranged on a bottom substrate facing the top substrate, the address electrodes crossing the scan and sustain electrodes; a bottom dielectric layer arranged on the address electrodes. The top dielectric layer includes a region overlapping the scan electrodes and a region overlapping the sustain electrodes, the region overlapping the scan electrodes having a different thickness than the region overlapping the sustain electrodes.

### CLAIM OR PRIORITY

This application makes reference to, incorporates the same herein, and claims all benefits accruing under 35 U.S.C. §119 from an application for PLASMA DISPLAY PANEL earlier filed in the Korean Intellectual Property Office on the 21 Nov. 2006 and there duly assigned Serial No. 10-2006-0115152.

### BACKGROUND OF THE INVENTION

1. Field of the Invention

The present invention relates to a Plasma Display Panel (PDP), and more particularly, the present invention relates to a PDP capable of cutting down the manufacturing cost and simultaneously displaying an image having a uniform luminance.

2. Description of the Related Art

In recent years, a Plasma Display Panel (PDP) displays an image including letters or graphics by allowing a phosphor to emit the light by means of 147 nm ultraviolet rays generated in discharging an inactive mixed gas. Such a PDP may be made thin and large, and also may provide a significantly improved image quality with development of recent techniques.

FIG. 1 is a view of a discharge cell of a PDP.

Referring to FIG. 1, the discharge cell of the PDP includes a scan electrode (Y) and a sustain electrode (X) formed on a top substrate 10 and an address electrode (A) formed on a bottom substrate 18. Each of the scan electrodes (Y) and the sustain electrodes (X) includes transparent electrodes (12Y, 12X) and metal bus electrodes (13Y, 13X) having a smaller line width than that of the transparent electrode (12Y,12X) and formed on an edge of one side of the transparent electrodes.

The transparent electrodes (12Y,12X) are formed on the top substrate 10 using Indium-Tin-Oxide (ITO). The metal bus electrodes (13Y,13X) are formed on the transparent electrodes (12Y, 12X) using metals, such as chromium (Cr), etc., to reduce a voltage drop caused by the transparent electrodes (12Y, 12X) having a high resistance. A top dielectric layer 14 and a passivation layer 16 are laminated on the top substrate 10 in which the scan electrodes (Y) and the sustain electrodes (X) are formed in parallel.

A wall charge generated in discharging the plasma is stored in the top dielectric layer 14. The passivation layer 16 prevents damage to the top dielectric layer 14 by sputtering generated by the discharging plasma and also improves the emission efficiency of secondary electrons. Magnesium Oxide (MgO) is generally used as the passivation layer 16.

A bottom dielectric layer 22 and a barrier rib 24 are formed on the bottom substrate 18 having an address electrode (A) formed therein, and surfaces of the bottom dielectric layer 22 and the barrier rib 24 are coated with a phosphor layer 26. The address electrode (A) is formed so that it crosses the scan electrodes (Y) and the sustain electrodes (X). The barrier rib 24 is formed as a stripe and/or mesh to prevent ultraviolet rays and visible rays, generated by the discharge, from being leaked to adjacent discharge cells. The phosphor layer 26 is excited by the ultraviolet rays generated by the discharging plasma to generate one of red, green and blue visible colors. An inactive mixed gas is injected into a discharge space arranged between the top/bottom substrates (10 and 18) and the barrier ribs 24.

In order to realize gray levels of an image, the PDP is driven in a time-sharing system by dividing one frame into several subfields having different emission cycles. Each of the subfields is divided into a reset period for resetting an entire screen; an address period for selecting cell while sequentially supplying a scan signal to the scan electrode (Y); and a sustain period for realizing gray levels according to the discharge cycles.

FIG. 2 are waveforms of a method of driving a PDP.

Referring to FIG. 2, the subfields of one frame is divided into a reset period (Ra), an address period (Aa) and a sustain period (Sa).

In the case of the reset period (Ra), a ground potential (Vg) is supplied to the scan electrodes (Y1 to Yn) and the address electrodes (A1 to Am) during the reset period (to˜t1), and a predetermined voltage (Ve) is supplied to the sustain electrodes (X1 to Xn). Therefore, the wall charge stored in the sustain electrodes (X1 to Xn) is lowered during a sustain period (Sa) of the previous subfield.

A lamp pulse increasing with a predetermined gradient is supplied to the scan electrodes (Y1 to Yn) and a ground potential (Vg) is supplied to the sustain electrodes (X1 to Xn) and the address electrodes (A1 to Am) during the period (t1˜t2) for storing a wall charge. Therefore, a negative wall charge is stored in the scan electrodes (Y1 to Yn) by a microdischarge caused by the lamp pulse, and a positive wall charge is stored in the sustain electrodes (X1 to Xn).

A lamp pulse decreasing with a predetermined gradient is supplied to the scan electrodes (Y1 to Yn) and a predetermined voltage (Ve) is supplied to the sustain electrodes (X1 to Xn) during a period (t2˜t3) for distributing a wall charge. A ground potential (Vg) supplied to the address electrodes (A1 to Am) during the period (t2˜t3) for distributing a wall charge. Therefore, the wall charges stored in the scan electrodes (Y1 to Yn) and the sustain electrodes (X1 to Xn) are decreased during the period (t1˜t2) for storing a wall charge. That is to say, generation of an excessive discharge is prevented during an address period (Aa) by decreasing the capacity of the wall charges stored in the discharge cells during the period (t2˜t3) for distributing a wall charge.

A scan signal is sequentially supplied to the scan electrodes (Y1 to Yn) during the address period (Aa), and a data signal synchronized with the scan signal is supplied to the address electrodes (A1 to Am). Therefore, an address discharge is generated in the discharge cells to which the data signal is supplied while adding a wall voltage generated during the reset period (Ra) to a voltage difference between the scan signal and the data signal. A wall charge required for the sustain discharge is generated in the discharge cell in which the address discharge is generated.

A sustain pulse is alternately supplied to the scan electrodes (Y1 to Yn) and the sustain electrodes (X1 to Xn) during the sustain period (Sa). Therefore, a sustain discharge is generated between the scan electrodes (Y) and the sustain electrodes (X) every when the sustain pulse is supplied while adding a voltage of the sustain pulse to a wall voltage of the discharge cells selected during the address discharge.

As described above, the PDP respectively supplies different driving waveforms to the scan electrodes (Y1 to Yn), the sustain electrodes (X1 to Xn) and the address electrodes (A1 to Am), as shown in FIG. 2. Accordingly, the PDP includes a scan driver for driving scan electrodes (Y1 to Yn); a sustain driver for driving sustain electrodes (X1 to Xn); and an address driver for driving address electrodes (A1 to Am). That is to say, the manufacturing cost of a PDP is increased since the PDP includes 3 drivers, and therefore its competitive power for expense is lowered.

### SUMMARY OF THE INVENTION

Accordingly, the present invention is designed to solve such drawbacks noted above, and it is therefore an object of the present invention to provide a Plasma Display Panel (PDP) having reduced manufacturing costs.

One embodiment of the present invention is achieved by providing a Plasma Display Panel (PDP) for supplying a sustain pulse only to scan electrodes among scan electrodes and sustain electrodes arranged on a top substrate during a sustain period of each subfield, the PDP including: a top dielectric layer arranged on the scan electrodes and sustain electrodes; a passivation layer arranged on the top dielectric layer; address electrodes arranged on the bottom substrate facing the top substrate to cross the scan electrodes and sustain electrodes; and a bottom dielectric layer arranged on the address electrodes; a region of the top dielectric layer overlapping the scan electrodes has a different thickness than a region of the top dielectric layer overlapping the sustain electrodes.

Another embodiment of the present invention is achieved by providing a Plasma Display Panel (PDP) including: a top dielectric layer arranged on scan electrodes and sustain electrodes; a passivation layer arranged on the top dielectric layer; address electrodes arranged on a bottom substrate facing a top substrate to cross the scan electrodes and sustain electrodes; and a bottom dielectric layer arranged on the address electrodes; a region of the top dielectric layer overlapping the scan electrodes has a different thickness than a region of the top dielectric layer overlapping the sustain electrodes.

Preferably, the region of the top dielectric layer overlapping the scan electrodes is thicker than the region of the top dielectric layer overlapping the sustain electrodes. The sustain electrode is supplied with a ground potential during the subfield period. The sustain pulse includes alternatively supplied positive and negative potentials. The PDP according to the present invention further includes a phosphor layer arranged on the bottom dielectric layer.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a view of a discharge cell of a Plasma Display Panel (PDP).

FIG. 2 are waveforms of a method of driving the PDP of FIG. 1.

FIG. 3 is a view of a PDP according to one embodiment of the present invention.

FIG. 4 are waveforms of a method of driving the PDP of FIG. 3.

FIG. 5 is a graph of a luminance generated in discharge cells if a driving waveform of FIG. 4 is supplied to scan electrodes (Y) and sustain electrodes (X).

FIG. 6A and FIG. 6B are views of discharge cells of the PDP according to one embodiment of the present invention.

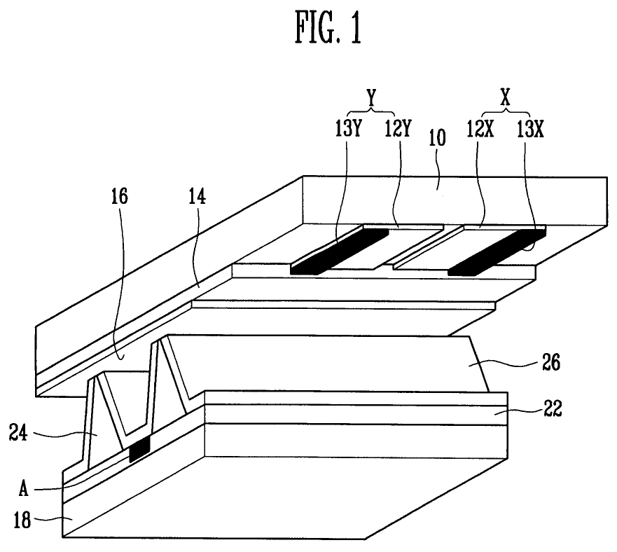

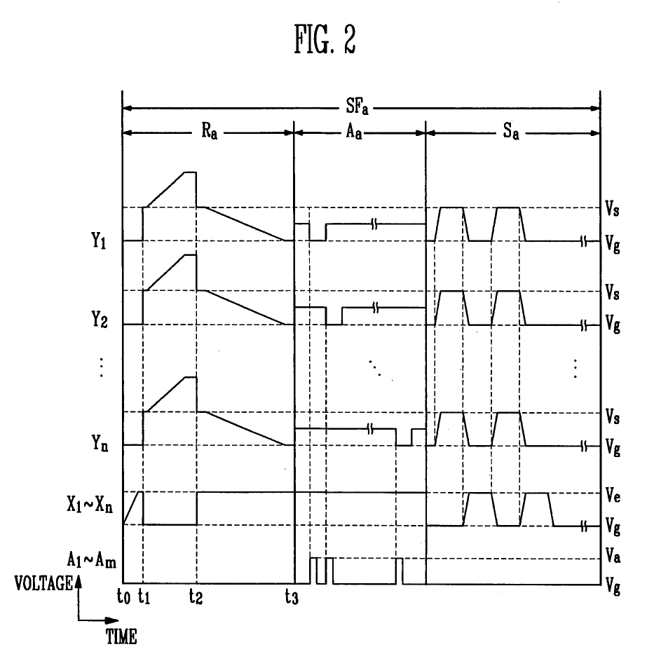

### DETAILED DESCRIPTION OF THE INVENTION

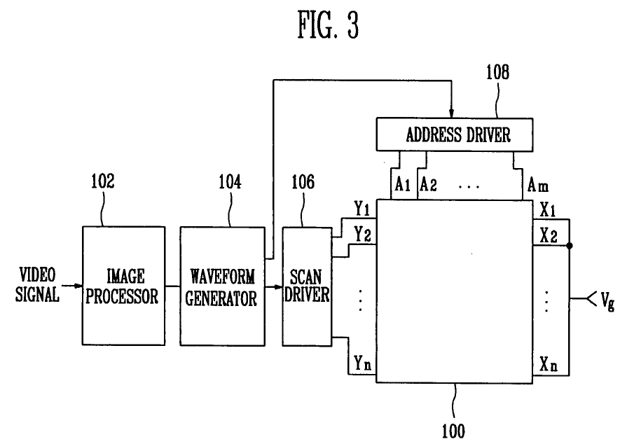

Hereinafter, exemplary embodiments of the present invention are described in detail with reference to the accompanying drawings. When one element is connected to another element, one element may be not only directly connected to another element but also indirectly connected to another element via another element. Furthermore, irrelevant elements have been omitted for clarity. Also, like reference numerals refer to like elements throughout. Although the exemplary embodiments of the present invention may be easily performed by those skilled in the art to which the present invention pertains, they are described in detail below with reference to FIG. 3 to FIG. 6B.

FIG. 3 is a view of a Plasma Display Panel (PDP) according to one embodiment of the present invention.

Referring to FIG. 3, the PDP according to one embodiment of the present invention includes a panel 100, an address driver 108, a scan driver 106, a waveform generator 104 and an image processor rejected under 35 U.S.C. §102 for alleged anticipation by

The image processor 102 receives an externally supplied analog video signal. The image processor 102 receiving the analog video signal converts the analog video signal into a digital video signal. The image processor 102 also generates a vertical synchronizing signal, a horizontal synchronizing signal and a clock signal, etc. and supplies the generated signals to the waveform generator 104.

The waveform generator 104 receives the digital video signal and the vertical synchronizing signal, the horizontal synchronizing signal and the clock signal. The waveform generator 104 receiving the digital video signal divides the digital video signal in every subfield, and supplies the divided video signal to the address driver 108. Also, the waveform generator 104 generates control signals to correspond to the vertical synchronizing signal, the horizontal synchronizing signal and the clock signal, and supplies the generated control signals to the scan driver 106 and the address driver 108.

The address driver 108 generates a data signal to correspond to data and control signals supplied to the address driver 108 itself, and supplies the generated data signal to the address electrodes (A1 to Am) during an address period of the subfields.

The scan driver 106 generates a scan signal to correspond to the control signals supplied to the scan driver 106 itself, and sequentially supplies the generated scan signal to the scan electrodes (Y1 to Yn) during an address period of the subfields. Also, the scan driver 106 supplies a lamp pulse to the scan electrodes (Y1 to Yn) during a reset period of the subfields, and supplies a sustain pulse to the scan electrodes (Y1 to Yn) during a sustain period.

As described above, the sustain electrodes (X1 to Xn) are connected to a ground potential (Vg) in the PDP of the present invention. If the sustain electrodes (X1 to Xn) are connected to the ground potential (Vg), its manufacturing cost may be lowered, compared to other PDPs (namely, one driver is not installed.).

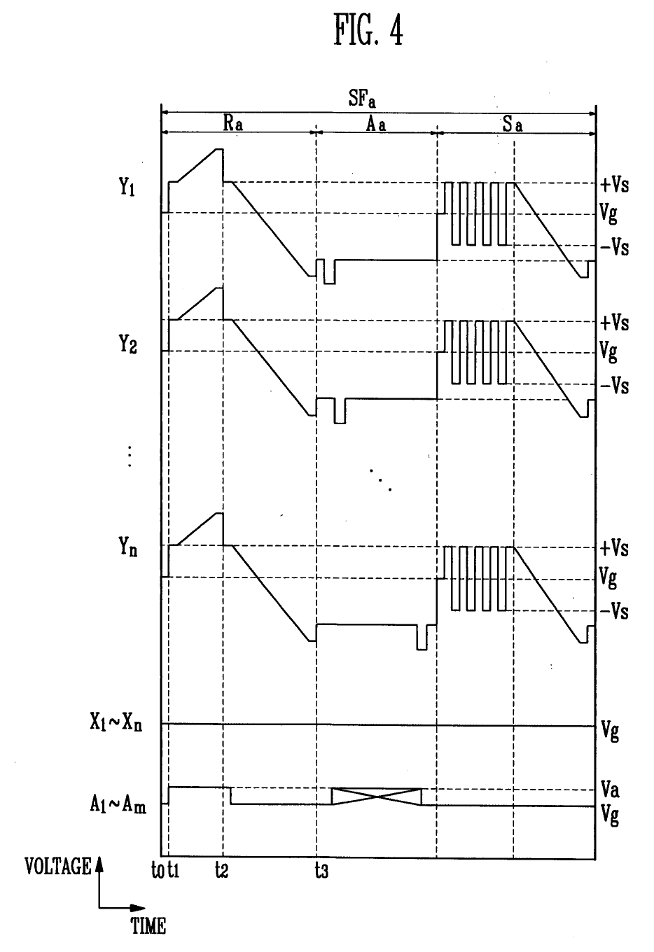

FIG. 4 is a view of driving waveforms of the PDP according to an embodiment of the present invention.

Referring to FIG. 4, the subfields of the PDP according to an embodiment of the present invention is divided into a reset period (Ra), an address period (Aa) and a sustain period (Sa).

In the reset period (Ra), a ground potential (Vg) is supplied to the scan electrodes (Y1 to Yn) the address electrodes (A1 to Am) and the sustain electrodes (X1 to Xn) during the reset period (to˜t1). Therefore, the wall charge generated during a period of the previous subfield is in part erased.

A lamp pulse increasing with a predetermined gradient is supplied to the scan electrodes (Y1 to Yn) and a ground potential (Vg) is supplied to the sustain electrodes (X1 to Xn) during the period (t1˜t2) for storing a wall charge. A predetermined potential (Va) is supplied to the address electrodes (A1 to Am) during the period (t1˜t2) for storing a wall charge. Therefore, microdischarges are generated between the scan electrodes (Y1 to Yn) and the sustain electrodes (X1 to Xn), and between the address electrodes (A1 to Am) and the scan electrodes (Y1 to Yn). A negative wall charge is stored in the scan electrodes (Y1 to Yn) by a microdischarge caused by the lamp pulse, and a positive wall charge is stored in the address electrodes (A1 to Am) and the sustain electrodes (X1 to Xn).

A lamp pulse decreasing with a predetermined gradient is supplied to the scan electrodes (Y1 to Yn) and a ground potential (Vg) is supplied to the sustain electrodes (X1 to Xn) and the address electrodes (A1 to Am) during a period (t2˜t3) for distributing a wall charge. Therefore, the wall charges stored in the discharge cells are decreased during the period (t1˜t2) for storing a wall charge. That is to say, the generation of an excessive discharge is prevented during an address period (Aa) by decreasing the capacity of the wall charges stored in the discharge cells during the period (t2˜t3) for distributing a wall charge.

A scan signal is sequentially supplied to the scan electrodes (Y1 to Yn) during the address period (Aa), and a data signal synchronized with the scan signal is supplied to the address electrodes (A1 to Am). Therefore, an address discharge is generated in the discharge cells to which the data signal is supplied while adding a wall voltage generated during the reset period (Ra) to a voltage difference between the scan signal and the data signal. A wall charge required for the sustain discharge is generated in the discharge cell in which the address discharge is generated.

A sustain pulse alternately having a positive sustain voltage (Vs) and a negative sustain voltage (−Vs) is supplied to the scan electrodes (Y1 to Yn) during the sustain period. A ground potential (Vg) is supplied to the sustain electrodes (X1 to Xn) and the address electrodes (A1 to Am) during the sustain period. A sustain discharge is then generated while adding a voltage of the sustain pulse to a wall voltage in the discharge cells selected during the address discharge. The cycles of the sustain discharge are determined according to the supply cycles of the sustain pulse.

As described above, one driver connected to the sustain electrodes (X1 to Xn) may be omitted in the present invention by supplying only a ground potential (Vg) to the sustain electrodes (X1 to Xn), and therefore its manufacturing cost may be lowered.

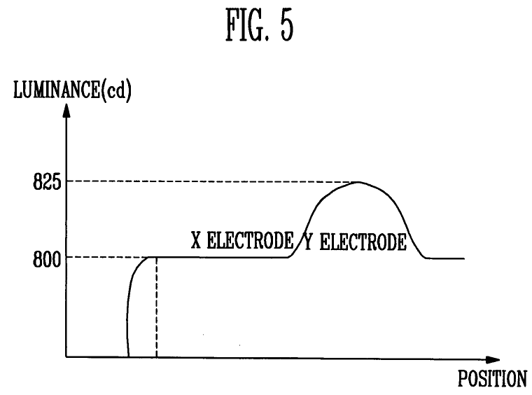

However, a luminance of a position where the scan electrodes (Y1 to Yn) are arranged is higher in one discharge cell than that of a position where the sustain electrodes (X1 to Xn) are arranged, as shown in FIG. 5, since the sustain pulse is supplied only to the scan electrodes (Y1 to Yn) in the present invention as described above. In this case, the panel may be spotted due to a non-uniformity of the luminance in the discharge cells. Also, an additional problem is that the top dielectric layer is broken in a region which is overlapped with the scan electrodes (Y1 to Yn) due to the excessive discharge in a region in which the scan electrodes (Y1 to Yn) are formed.

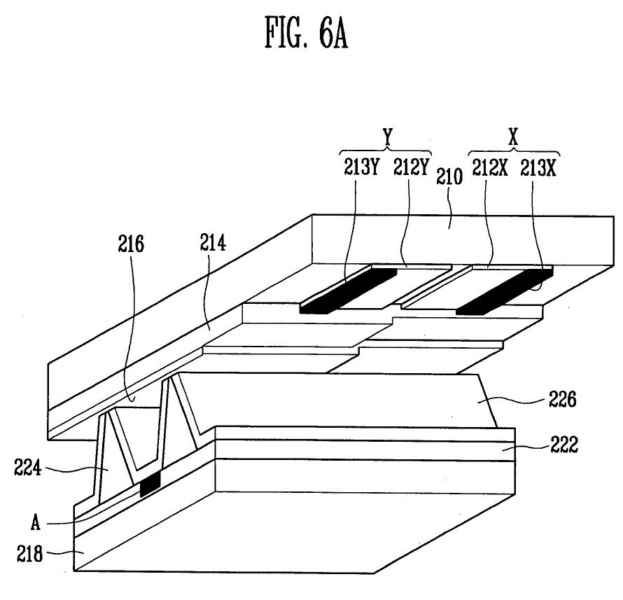

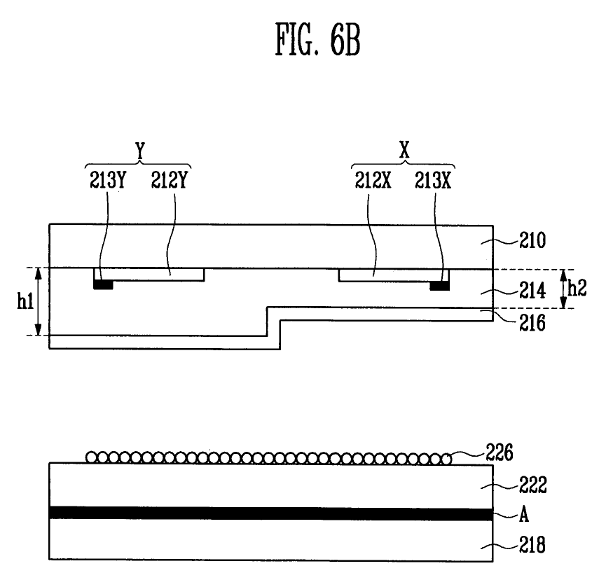

In order to solve the above problem, the present invention proposes a discharge cell, as shown in FIG. 6A and FIG. 6B.

FIG. 6A and FIG. 6B are views of a discharge cell according to one embodiment of the present invention.

Referring to FIG. 6A and FIG. 6B, the discharge cell of the PDP according to the embodiment of the present invention includes a scan electrode (Y) and a sustain electrode (X) formed on a top substrate 210 and an address electrode (A) formed on a bottom substrate 218. Each of the scan electrodes (Y) and the sustain electrodes (X) includes transparent electrodes (212Y,212X); and metal bus electrodes (213Y,213X) having a smaller line width than those of the transparent electrodes (212Y,212X) and formed on an edge of one side of the transparent electrode.

The transparent electrodes (212Y,212X) are formed on the top substrate 210 using a transparent material (for example, ITO). The metal bus electrodes (213Y,213X) are formed on the transparent electrodes (212Y,212X) using a metal having a high conductivity (for example, chromium (Cr)), and therefore they serve to reduce a voltage sag caused by the transparent electrodes (212Y, 212X) having a high resistance. A top dielectric layer 214 and a passivation layer 216 are laminated on the top substrate 210 in which the scan electrode (Y) and the sustain electrode (X) are formed in parallel.

A wall charge generated in discharging plasma is stored in the top dielectric layer 214. Such a top dielectric layer 214 is set so that a region (h1) overlapped with the scan electrode (Y) has a different thickness from a region (h2) overlapped with the sustain electrode (X). That is to say, the top dielectric layer 214 is set so that the region (h1) overlapped with the scan electrode (Y) is thicker than the region (h2) overlapped with the sustain electrode (X). If the top dielectric layer 214 is set to be thicker in the region overlapped with the scan electrode (Y) as described above, the non-uniformity of the luminance in the discharge cells may be reduced. That is to say, the light having a uniform luminance is generated in the position where the scan electrode (Y) is arranged and the position where the sustain electrode (X) is arranged since a weak discharge is generated if a thicker top dielectric layer 214 is formed in the region overlapped with the scan electrode (Y). Also, the breakdown of the top dielectric layer 214 may be prevented in the region overlapped with the scan electrode (Y) if a thicker top dielectric layer 214 is formed.

The passivation layer 216 prevents the breakdown of the top dielectric layer 214 caused by sputtering generated by the discharging plasma, and also improves an emission efficiency of secondary electrons. Magnesium oxide (MgO) can form the passivation layer 216.

A bottom dielectric layer 222 and a barrier rib 224 are formed on the bottom substrate 218 having the address electrodes (A) formed therein, and surfaces of the bottom dielectric layer 222 and the barrier rib 224 are coated with a phosphor layer 226. The address electrode (A) is formed so that it crosses the scan electrodes (Y) and the sustain electrodes (X). The barrier rib 224 is formed as a stripe and/or mesh to prevent ultraviolet rays and visible rays, generated by the discharge, from being leaked to adjacent discharge cells. The phosphor layer 226 is excited by the ultraviolet rays generated by the discharging plasma to generate red, green or blue visible light. An inactive mixed gas is injected into a discharge space arranged between the top/bottom substrates (210 and 218) and the barrier rib 224.

As described above, the PDP according to the embodiment of the present invention may be useful to remove the driver connected to the sustain electrodes (X) by supplying a sustain pulse only to the scan electrodes (Y), and therefore its manufacturing cost may be lowered. According to the present invention, a light having a uniform luminance may be generated in the discharge cells by setting a top dielectric in a region overlapped with the scan electrode (Y) to be thicker than that of a top dielectric in a region overlapped with the sustain electrode (X). Also, the breakdown of the top dielectric layer may be prevented if the top dielectric is set to be thicker in the region overlapped with the scan electrode (Y).

The description noted above is just an exemplary example for the purpose of illustration only, not intended to limit the scope of the present invention, so it should be understood that other equivalents and modifications could be made thereto without departing from the spirit and scope of the present invention as apparent to those skilled in the art. Therefore, it should be understood that the present invention is not defined within the scope of the detailed description but rather within the scope defined by the following claims.

What is claimed is:

1. A Plasma Display Panel (PDP) supplying a sustain pulse only to scan electrodes among scan electrodes and sustain electrodes arranged on a top substrate during a sustain period of each of a plurality of subfields, the PDP comprising:
a top dielectric layer arranged on the scan electrodes and the sustain electrodes;
a passivation layer arranged on the top dielectric layer;
address electrodes arranged on a bottom substrate facing the top substrate, the address electrodes crossing the scan electrodes and the sustain electrodes; and
a bottom dielectric layer arranged on the address electrodes;
wherein the top dielectric layer includes a region overlapping the scan electrodes and a region overlapping the sustain electrodes, the region overlapping the scan electrodes having a different thickness than the region overlapping the sustain electrodes.

2. The PDP according to claim 1, wherein the region of the top dielectric layer overlapping the scan electrodes is thicker than the region of the top dielectric layer overlapping the sustain electrodes.

3. The PDP according to claim 1, wherein the sustain electrodes are supplied with a ground potential during a subfield period.

4. The PDP according to claim 1, wherein the sustain pulse comprises alternatively supplied positive and negative potentials.

5. The PDP according to claim 1, further comprising a phosphor layer arranged on the bottom dielectric layer.

6. A Plasma Display Panel (PDP) comprising:
a top dielectric layer arranged on scan electrodes and sustain electrodes;
a passivation layer arranged on the top dielectric layer;
address electrodes arranged on a bottom substrate facing a top substrate, the address electrodes crossing the scan electrodes and the sustain electrodes; and
a bottom dielectric layer arranged on the address electrodes;
wherein the top dielectric layer includes a region overlapping the scan electrodes and a region overlapping the sustain electrodes, the region overlapping the scan electrodes having a different thickness than the region overlapping the sustain electrodes.

7. The PDP according to claim 6, wherein the region of the top dielectric layer overlapping the scan electrodes is thicker than the region of the top dielectric layer overlapping the sustain electrodes.

8. The PDP according to claim 6, wherein the sustain electrodes are supplied with a ground potential during a subfield period.

9. The PDP according to claim 6, wherein the sustain pulse comprises alternatively supplied positive and negative potentials.

10. The PDP according to claim 6, further comprising a phosphor layer arranged on the bottom dielectric layer.
